(19) United States
(12) Patent Application Publication
(10) Pub. No.: US 2014/0210305 A1
(43) Pub. Date: Jul. 31, 2014

(54) SINGLE PHASE SWITCHED RELUCTANCE MACHINE WITH AXIALLY EXTENDING STATOR LAMINATIONS

(71) Applicant: Everette Energy, LLC., Dallas, TX (US)

(72) Inventor: Babak Fahimi, Arlington, TX (US)

(73) Assignee: EVERETTE ENERGY, LLC, Dallas, TX (US)

(21) Appl. No.: 14/163,989

(22) Filed: Jan. 24, 2014

Related U.S. Application Data
(60) Provisional application No. 61/756,992, filed on Jan. 25, 2013.

(51) Int. Cl. H02K 1/14

(52) U.S. Cl. CPC H02K 1/141
USPC 310/216.026

(57) ABSTRACT

A reluctance machine includes a stator having a plurality of stator poles and a rotor having a plurality of rotor poles and configured to rotate about an axis of rotation. Each of the stator poles includes a primary stator pole and an auxiliary stator pole. The auxiliary stator pole is axially aligned with the primary stator pole in the direction of the axis of rotation.

Furthermore, each stator poles is formed of a plurality of laminations extending in a direction parallel to the axis of rotation.

### PRIORITY CLAIM

This application claims priority from United States Provisional Application for Patent No.

61/756,992 filed Jan. 25, 2013, the disclosure of which is incorporated by reference.

### TECHNICAL FIELD

The present invention relates to switched reluctance machines.

### BACKGROUND

Reluctance machines are well known in the art. These machines operate on the tendency of the machine's rotor to move to a position where the reluctance with respect to the stator is minimized (in other words, where the inductance is maximized). This position of minimized reluctance occurs where the rotor pole is aligned with an energized stator pole. When operated as a motor, energizing the stator pole generates a magnetic field attracting the closest rotor pole towards the stator pole. This magnetic attraction produces a torque causing the rotor to rotate and move towards the minimized reluctance position. Conversely, when operated as a generator, torque applied to the rotor is converted to electricity as the rotor pole moves away from the aligned position with respect to an energized stator pole.

### SUMMARY

In an embodiment, a reluctance machine comprises: a stator having a plurality of stator poles; and a rotor having a plurality of rotor poles and configured to rotate about an axis of rotation; wherein each of the stator poles comprises: a primary stator pole; and an auxiliary stator pole, wherein the auxiliary stator pole is axially aligned with the primary stator pole in the direction of the axis of rotation; and wherein each stator pole is formed of a plurality of laminations extending in a direction parallel to the axis of rotation.

In an embodiment, a reluctance machine comprises: a rotor having a plurality of rotor poles and configured to rotate about an axis of rotation; a stator having a plurality of stator poles, each stator pole comprising: a primary stator pole; and an auxiliary stator pole, wherein each stator pole is formed of a plurality of laminations, said laminations extending in a direction parallel to the axis of rotation; and wherein each lamination includes a first leg forming part of the primary stator pole, a second leg forming part of the auxiliary stator pole and a bridge member extending perpendicular to and joining the first and second legs.

### BRIEF DESCRIPTION OF THE DRAWINGS

FIG. 1 illustrates an exemplary single phase switched reluctance machine;

FIG. 2 illustrates a front view of the single phase switched reluctance machine;

FIG. 3 illustrates a rear view of the single phase switched reluctance machine;

FIG. 4 illustrates a perspective view of a rotor pole and stator pole at a rotational position of minimum reluctance;

FIG. 5 illustrates a side view along an axial direction of a rotor pole and stator pole at a rotational position of minimum reluctance;

FIGS. 5A-5F show simulation data for the switched reluctance machine;

FIG. 6 illustrates a rotor configuration;

FIG. 7 illustrates an exemplary circuit for connecting windings;

FIG. 8 is a perspective view of a portion of the switched reluctance machine;

FIG. 9 is a block diagram of a control circuit;

FIG. 10 illustrates a stacked switched reluctance machine; and

FIGS. 11A-11D illustrate a drive circuit and its operation;

### DETAILED DESCRIPTION OF THE DRAWINGS

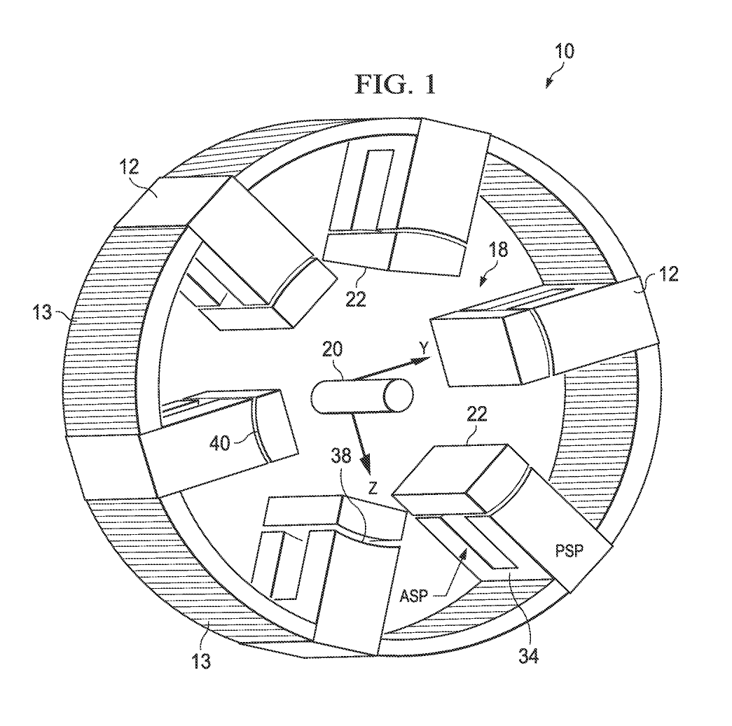

Reference is now made to FIG. 1 which illustrates an exemplary single phase switched reluctance machine of the 6/6 topology. The reference to “6/6” indicates that the machine has six rotor poles and six stator poles. The reference to “single-phase” indicates that there is only one stator energizing phase, and thus each of the six windings on the stator are energized simultaneously.

The stator 10 includes six poles 12. The six stator poles 12 are connected by a non-magnetic spacer segment 13 in between each two poles. The rotor 18 is mounted to a shaft 20 (illustrated in schematic view only), and the shaft is supported by a housing and bearings (not shown) that allow for rotational movement of the rotor relative to the stator 10. The rotor 18 also includes six poles 22 (which in a preferred implementation are magnetically isolated from each other). The rotor 18 is formed from at least one spoked web member (see, FIG. 6), with a rotor pole 22 mounted at the distal end of each spoke of the spoked web member. Other configurations for supporting the rotor poles 22 relative to the shaft 20 may be provided as known to those skilled in the art.

It will be understood that the illustrated 6/6 topology is exemplary only and that the single phase switched reluctance machine may have any desired even number of poles. In other words, the single phase switched reluctance machine may have an N/N topology, where N is an even or odd integer.

More particularly, the single phase switched reluctance machine is generally of the N/N* topology. The reference to “N/N*” indicates that the machine has N rotor poles and N* stator poles, wherein the “*” designation indicates that each of the N stator poles comprises the combination of a primary stator pole PSP and an axially aligned auxiliary stator pole ASP (the axial alignment being in the direction of the axis of rotor rotation and the axially aligned PSP and ASP having a common angle of minimum reluctance (or maximum inductance) relative to the rotor pole 22). The windings of the primary stator pole PSP and axially aligned auxiliary stator pole ASP are simultaneously excited and provide an axial path for magnetic flux as will be described in more detail below.

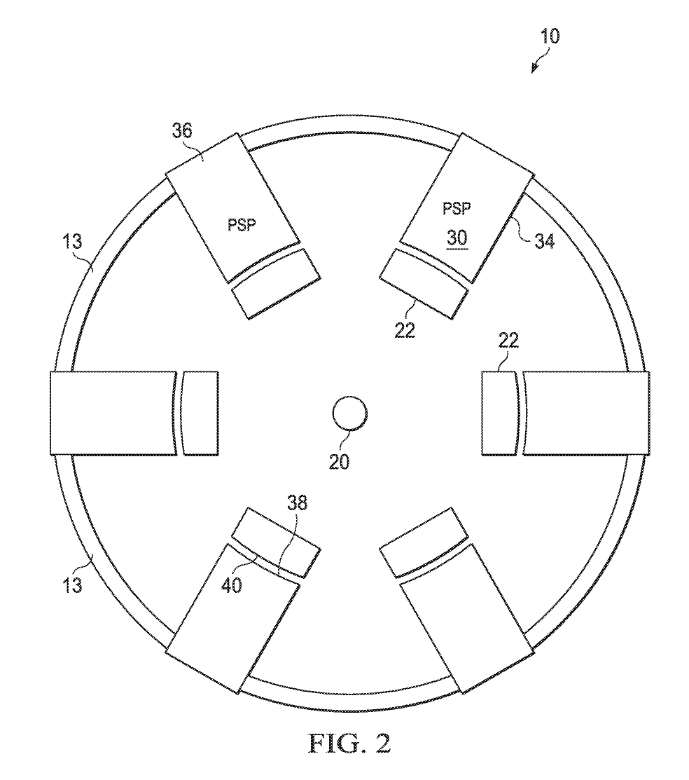

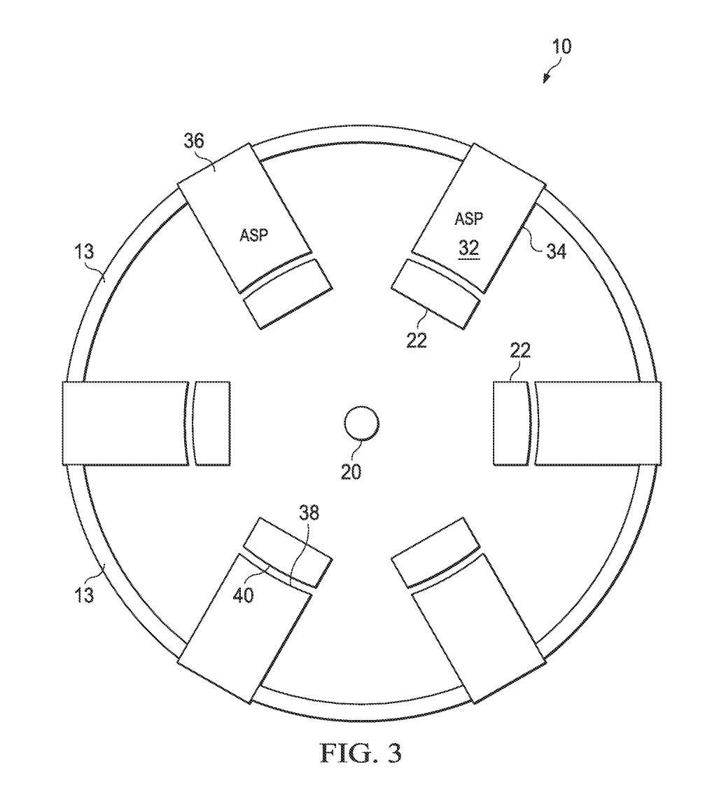

FIG. 2 illustrates a front view of the single phase switched reluctance machine of FIG. 1, and thus shows the placement of the PSPs. FIG. 3 illustrates a rear view of the single phase switched reluctance machine of FIG. 1, and thus shows the placement of the ASPs. For simplification of the illustration, FIGS. 2 and 3 schematically show the shaft 20, but do not explicitly illustrate the connection of the shaft to the included rotor poles 22. That connection may be made in any suitable manner known to those skilled in the art (including, for example, the use of a spoked web member as discussed above and shown in FIG. 6).

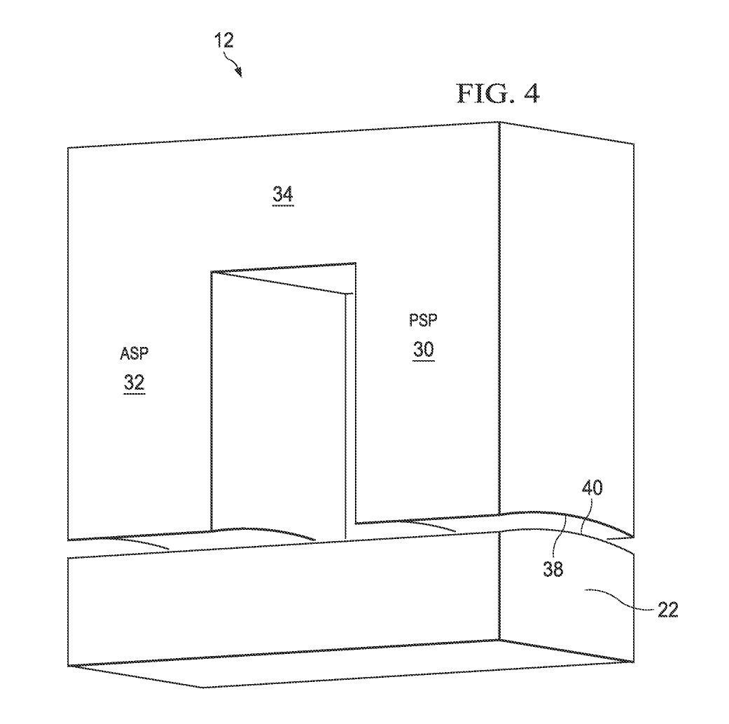

FIG. 4 illustrates a perspective view of rotor pole 22 and stator pole 12 at a rotational position of minimum reluctance (or maximum inductance). The stator pole is formed of the primary stator pole PSP which is axially aligned with the auxiliary stator pole ASP. The stator pole 12 is formed of a plurality of U-shaped metal laminations (see, also FIG. 8). One leg 30 of the U-shape defines the PSP and the other leg 32 of the U-shape defines the ASP. The bridge 34 between the legs 30 and 32 of the U-shape defines a part of the outer ring 36 of the single phase switched reluctance machine (see FIGS. 1-3). It will be noted that the laminations for the stator pole 12 extend in a plane that is parallel to the axis of rotor rotation. In other words, the laminations of the stator pole 12 are axially extending or axially oriented. Thus, the laminations support an axial path for magnetic flux when the windings of the primary stator pole PSP and axially aligned auxiliary stator pole ASP are simultaneously excited.

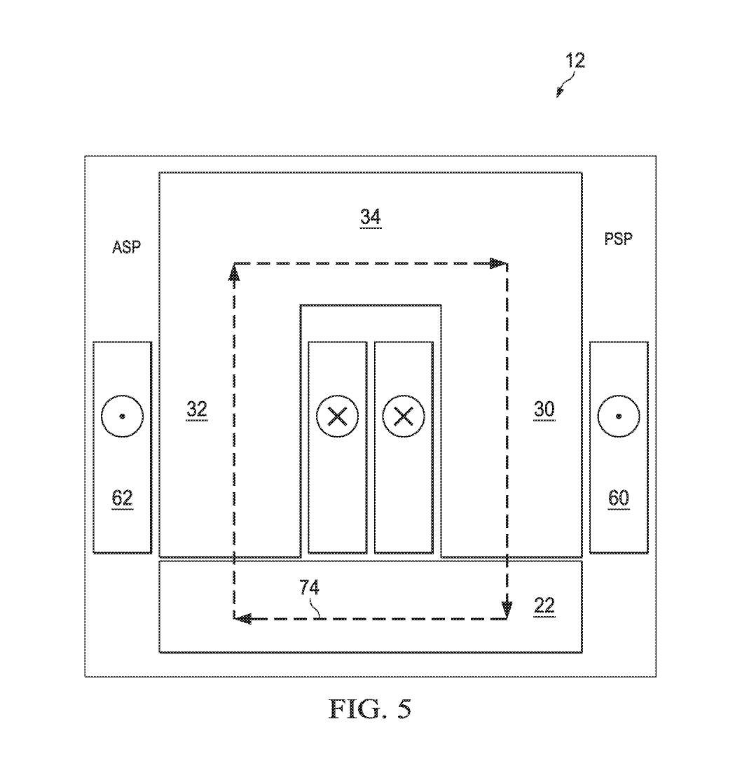

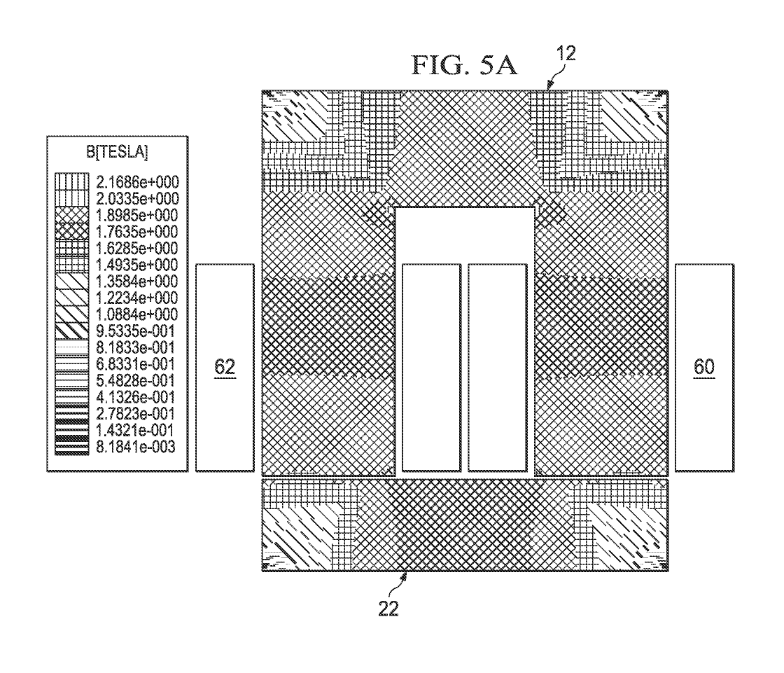

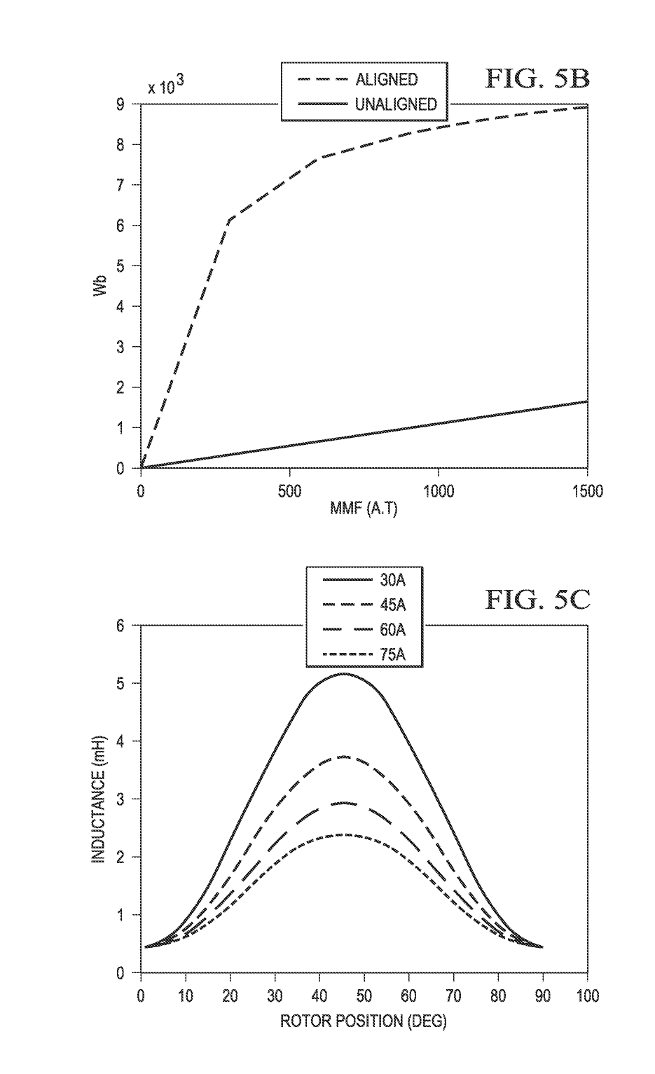

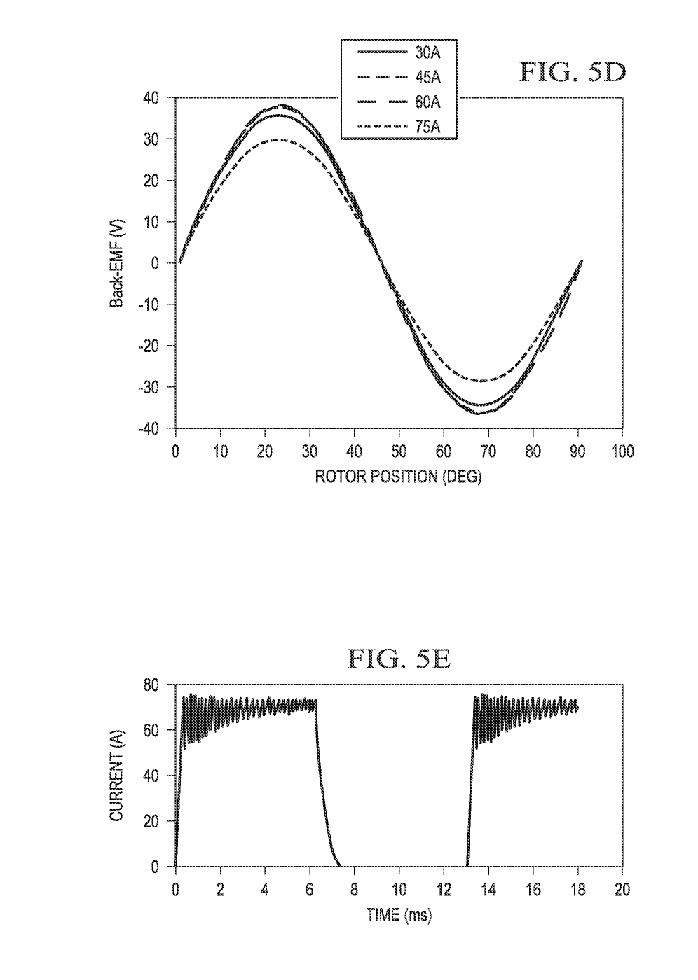

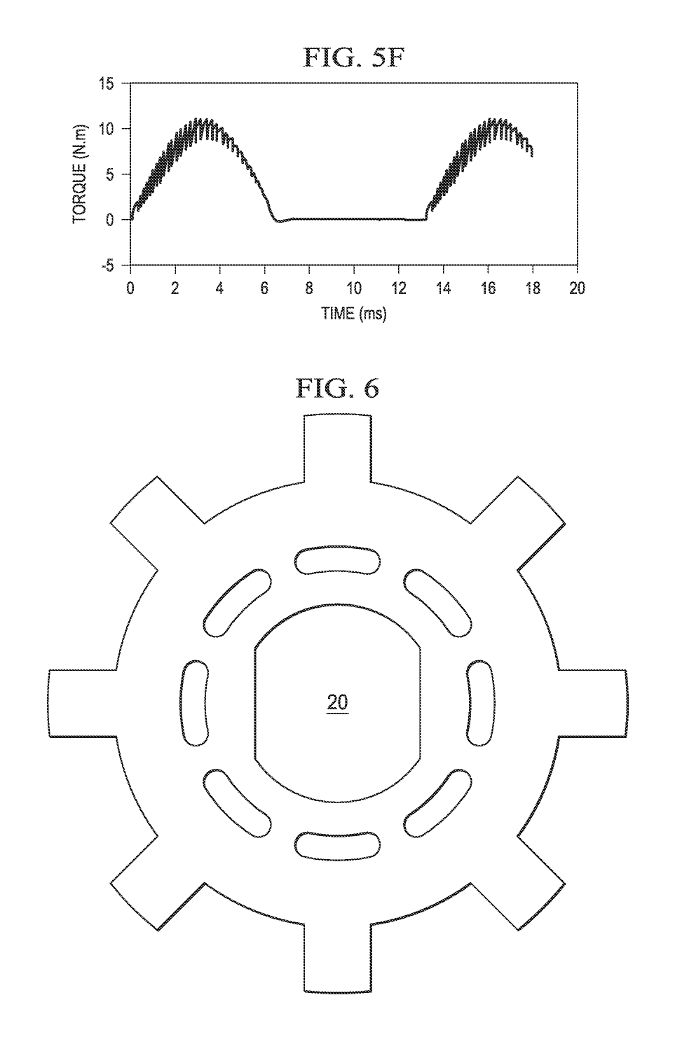

Illustration of the windings for the stator poles 12 is omitted in FIGS. 1-4 because the primary stator pole PSP and axially aligned auxiliary stator pole ASP are separately wound and this cannot be adequately illustrated. More detail on the separate windings provided for the stator poles 12 (i.e., the primary stator pole PSP and auxiliary stator pole ASP) is provided in FIG. 5.

The rotor pole 22 extends in an axial direction parallel to the shaft 20. The rotor poles 22 have an axial length substantially equal to a combined axial length of the PSP and ASP. In other words, each rotor pole 22 has an axial length sufficient to substantially and simultaneously cover the primary stator pole PSP and auxiliary stator pole ASP. The rotor pole 22 may be made a plurality of bar shaped laminations. These laminations for the rotor pole 22 extend in a plane that is parallel to the axis of rotor rotation. In other words, the laminations of the rotor pole 22 are axially extending or axially oriented. Alternatively, the rotor pole may be made of solid metal bar stock.

The air gap between the rotor pole 22 and the stator pole 12 has a substantially constant spacing in the circumferential direction. This is accomplished by forming the PSP and ASP of the stator pole 12 to have a concave inner surface 38 and forming the rotor pole 22 to have a convex outer surface 40.

Reference is now made to FIG. 5. The primary stator pole PSP and the axially aligned auxiliary stator pole ASP of each included stator pole 12 are separately wound.

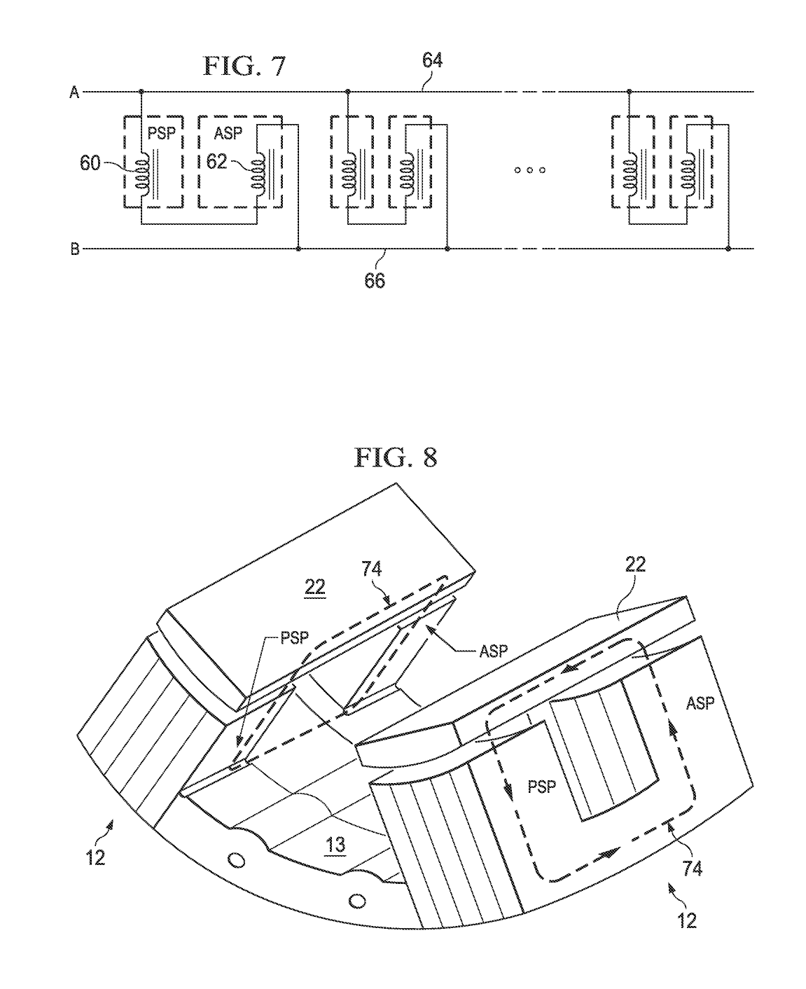

Each primary stator pole PSP is wound with a winding 60. The winding direction for current flow for each winding 60 is indicated using the “x” and “•” nomenclature as known by those skilled in the art. Each auxiliary stator pole ASP is wound with a winding 62. The winding direction for current flow for each winding 62 is indicated using the “x” and “•” nomenclature as known by those skilled in the art. It will be noted that the winding directions for the PSP and ASP are opposite. Thus, the PSP and ASP will have opposite magnetic orientations (for example, the PSP will present a north magnetic orientation and the ASP will present a south magnetic orientation). The winding 60 and winding 62 are connected in series and are simultaneously actuated during motor operation (see, FIG. 7). In this regard it will be remembered that this is a single phase switched reluctance machine.

The illustrated PSP and ASP windings are repeated for all stator poles 12 and the series connected windings 60 and 62 are connected in parallel between a first node A 64 and second node B 66 (see, FIG. 7). Thus, in an implementation, all PSPs will exhibit a winding orientation producing north magnetic orientations, and all ASPs will exhibit a winding orientation producing south magnetic orientations. In an alternative implementation, adjacent PSPs will exhibit opposite winding orientations (so that the magnetic orientation of the primary stator poles PSP when actuated alternates /S-N-S-N-S-N/ around the circumference of the stator 10) and axially adjacent ASPs will exhibit opposite winding orientations (so that the magnetic orientation of the auxiliary stator poles ASP when actuated alternates /N-S-N-S-N-S/ around the circumference of the stator 10).

Although FIG. 7 illustrates the series connection of windings 60 and 62, it will be understood that windings 60 and 62 could alternatively be connected in parallel.

The complete magnetic flux path 74 is shown in FIGS. 5 and 8. The single phase switched reluctance machine is accordingly a two air gap machine and the flux path is a short flux path that is constrained by the axially extending stator laminations and the axially extending rotor pole. See also, FIG. 8. Thus, the flux path axially travels along the rotor pole, crosses a first air gap to the primary stator pole, continues to travel radially through the primary stator pole, then travels axially along the bridge to the auxiliary stator pole, travels radially along the auxiliary stator pole, and crosses a second air gap to the rotor pole.

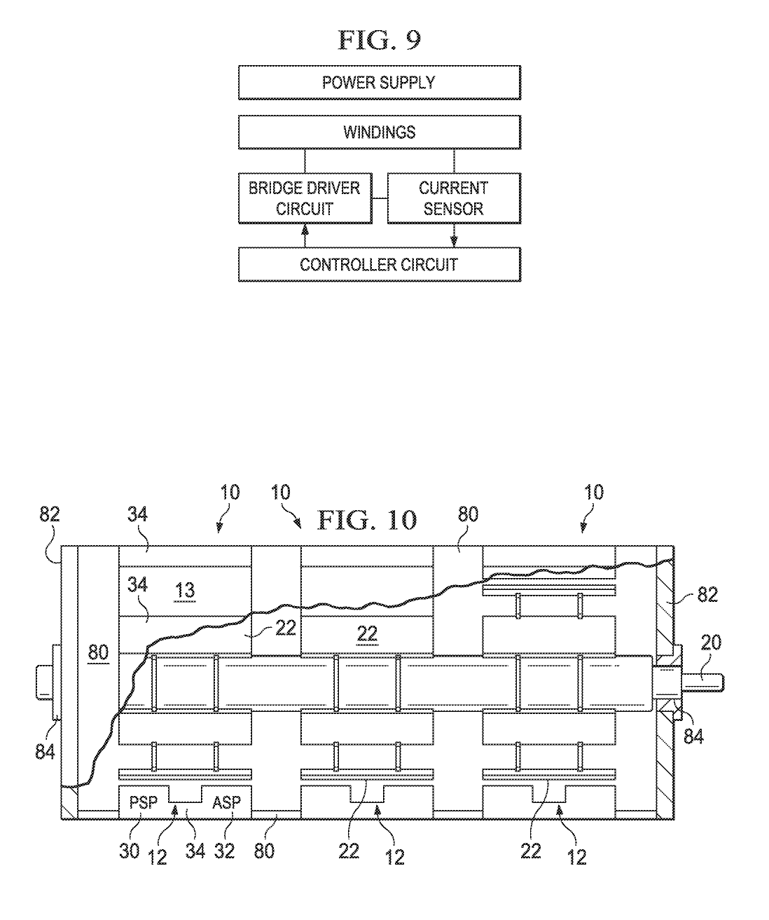

Reference is now made to FIG. 9. The control circuitry for the motor is of conventional design known to those skilled in the art. The controller circuit may, for example, comprise a digital signal processor (DSP) programmed to implement drive control. A bridge driver circuit is provided to drive the motor windings. The bridge driver circuit may comprise an asymmetric-bridge or full bridge configuration. The driver transistors within the bridge driver circuit receive gate control signals output from the controller circuit DSP. A current sensor is coupled to the motor windings to sense current passing through the motor windings and provide the sensed current information to the controller circuit DSP. The sensed current information is evaluated during the motoring phase of operation and used to determine when to actuate the driver transistors within the bridge driver circuit. A hysteresis control algorithm may be used during the motoring phase. An idle phase will be used for detection of the commutation instants. This is accomplished by energizing the idle phase of the stator with a series of high frequency voltage pulses. The main converter is used for this purpose. By precise monitoring of the diagnostic current, one can detect the commutation instant for the motoring mode of operation. It is important to note that the magnitude of the sensed diagnostic current depends inversely on the inductance and thereby introducing a one-on-one corresponding between the rotor position and the magnitude of the diagnostic current.

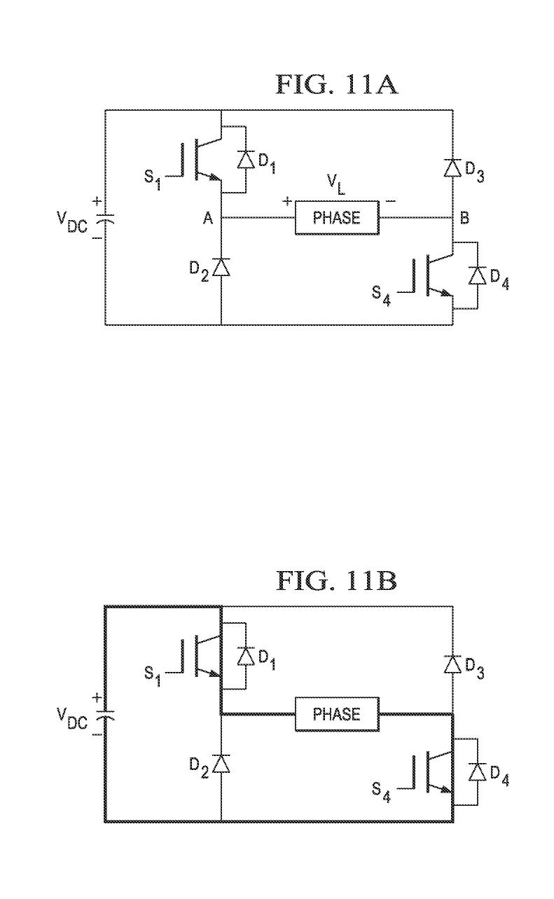

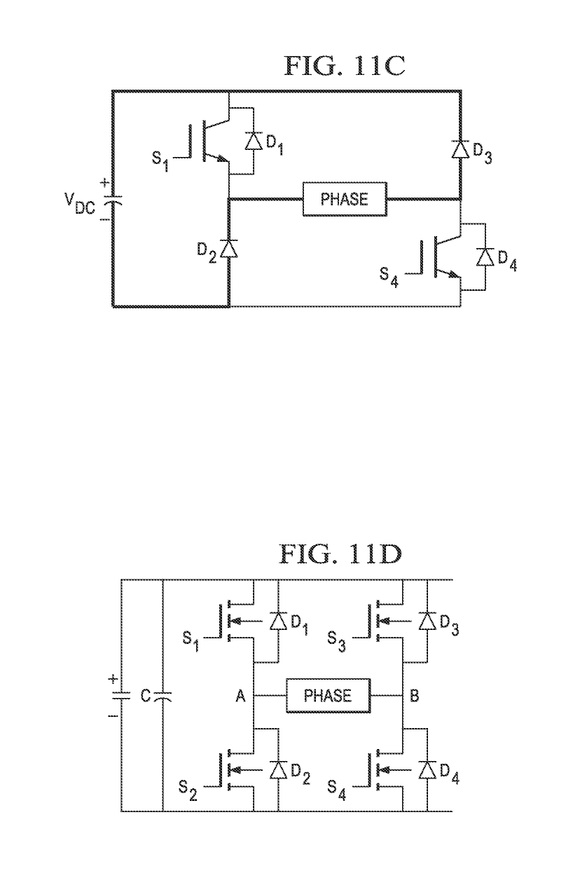

The bridge driver circuit may comprise an asymmetric-bridge (FIGS. 11A-11C) or full bridge (FIG. 11D) coupled to all the windings of the machine at node A 64 and node B 66. Alternatively, separate asymmetric-bridge or full bridge circuits could be used for each axially aligned pair of PSP and ASP windings.

The machine as shown in FIGS. 1-4, when configured as a motor, is not self-starting because the rotor could stop rotating at a position where the rotor poles were aligned with the stator poles (the minimized reluctance position). To address this issue, the motor of FIGS. 1-4 could further include a parking magnet which attracts the rotor poles to a position offset from the stator poles and from which starting is possible. Alternatively, the rotor poles could be shaped with a configuration that permits self-starting from any rotor position including when aligned with the stator poles. Parking magnet and self-starting rotor pole shape solutions are well known to those skilled in the art.

Reference is now made to FIG. 10. In a further embodiment, multiple switched reluctance machines (one such machine as is shown in FIGS. 1-4) can be stacked on a common shaft 20 (supported by end caps 82 and bearings 84). The machines are separated by spacer rings 80. By angularly offsetting the multiple machines from each other, the stacked machine presents a motor configuration that is self-starting because the rotor poles of at least one of the machines will be sufficiently offset from the stator poles to allow for magnetic attraction and torque generation. For example, the angular offset could be introduced by angularly offsetting the stator poles and keeping the rotor poles in alignment. Alternatively, the angular offset could be introduced by angularly offsetting the rotor poles and keeping the stator poles in alignment. An angular offset of 360/(M*N) degrees between each of the included machines is acceptable (when M is the number of machines in the stack). In a preferred implementation, the angular offset may, for example, comprise 10-25 degrees.

FIG. 10 is merely representative of a stacked configuration with aligned rotor poles, but it does not precisely illustrate the angular offset of the stator poles.

The bridge driver circuitry will preferably comprise a separate bridge driver circuit(s) for each machine in the stack so as to exercise separate phase control over the operation of each individual machine.

Reference is now made to Table 1 which illustrates power and envelope dimension of an exemplary embodiment of the machine for different numbers of stacks:

| Number of | | Power at | Power at | | Stack | |
|---|---|---|---|---|---|---|
| stacks | Torque | 1200 rpm | 3600 rpm | OD | length | |
| 1 | 5.5 NM | 687 W | 2061 W | 8.56 inch | 2.332 | inch |
| 3 | 16.5 NM | 2061 W | 6183 W | 8.56 inch | 7 | inch |
| 6 | 33 NM | 4122 W | 12,366 W | 8.56 inch | 14 | inch |
| 7 | 38.5 NM | 4809 W | 14,427 W | 8.56 inch | 16.32 | inch |

Reference is now made to Table 2 which describes the winding specifics for an exemplary embodiment of the machine (1200 rpm, 5 kW design):

| | Number of | |
|---|---|---|
| Windings | turns | Wire gauge |
| Primary winding | 19 | 8 AWG17 paralleled or equivalent |
| Auxiliary winding | 19 | 8 AWG17 paralleled or equivalent |

Reference is now made to Table 3 which describes the winding specifics for an exemplary embodiment of the machine (3600 rpm, 2 kW design):

| | Number of | |
|---|---|---|
| Windings | turns | Wire gauge |
| Primary winding | 8 | 20 AWG17 paralleled or equivalent |
| Auxiliary winding | 8 | 20 AWG17 paralleled or equivalent |

FIG. 5A illustrates a finite element analysis (FEA) simulation for flux for one rotor/stator pair. FIG. 5B illustrates the flux linkage with six coils at unaligned and aligned positions.

As shown in FIG. 6, the saturation and saliency is increased in the presented geometry. Average torque can be estimated according to the co-energy as follows,

$$\begin{matrix}{T}_{ave} = \frac{{W}_{c}}{{θ}_{a} - {θ}_{u}} * 45 ° / 90 ° \\ = \frac{{\int }_{0}^{I} {L}_{a} ( {θ}_{a} , i ) i d i - {\int }_{0}^{I} {L}_{u} ( {θ}_{u} , i ) i d i}{{θ}_{a} - {θ}_{u}} * 45 o / 90 o \\ = 8.6835 J / 0.785 rad * 1 / 2 \\ = 5.5 N . m\end{matrix}$$

Therefore, for six stator stacks, it is 5.5*6=33 N·m. At 1200 rpm, the overall output power is 4.12 kW and each stack only generates 687 W.

FIG. 5C illustrates the inductance of an exemplary embodiment of the machine as a function of rotor position and for different values of current.

FIG. 5D illustrates the back EMF of an exemplary embodiment of the machine for different values of current.

TABLE 4
illustrates an exemplary setup for
dynamic operation of the machine,

| Control | Conventional Hysteresis control | |
|---|---|---|
| Speed | 1200 | rpm |
| DC bus voltage | 300 | V |
| Turn-on angle | 1 | degree |
| Turn-off angle | 43 | degree |

| | |
|---|---|
| Regulated current | 75 A (Maximum MMF 1500 A.T) |

FIG. 5E illustrates an exemplary drive current waveform as a function of time.

FIG. 5F illustrates an exemplary torque waveform as a function of time.

Although the embodiments illustrated and described herein relate to a reluctance machine where the rotor is inside the stator, it will be understood that the disclosed reluctance machine could alternatively be configured with the stator inside the rotor.

Although preferred embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A reluctance machine, comprising:
a stator having a plurality of stator poles; and
a rotor having a plurality of rotor poles and configured to rotate about an axis of rotation;
wherein each of the stator poles comprises:
a primary stator pole; and
an auxiliary stator pole,
wherein the auxiliary stator pole is axially aligned with the primary stator pole in the direction of the axis of rotation; and
wherein each stator pole is formed of a plurality of laminations extending in a direction parallel to the axis of rotation.

2. The machine of claim 1, wherein each stator pole of the plurality of stator poles is magnetically isolated from each other stator pole of the plurality of stator poles.

3. The machine of claim 1, wherein the plurality of laminations define a single primary stator pole and a single auxiliary stator pole.

4. The machine of claim 1, wherein each lamination of the plurality of laminations has a U-shape with one leg of the U-shape defining the primary stator pole and another leg of the U-shape defining the auxiliary stator pole.

5. The machine of claim 1, wherein each rotor pole has a length extending in the direction of the axis of rotation sufficient to at least partially cover both the primary stator pole and axially aligned auxiliary stator pole.

6. The machine of claim 5, wherein a flux path passes axially along the rotor pole, across a first air gap and radially along the primary stator pole, axially along the stator, radially along the auxiliary stator pole and across a second air gap to the rotor pole.

7. The machine of claim 1, wherein each rotor pole of the plurality of rotor poles is magnetically isolated from each other rotor pole of the plurality of rotor poles

8. The machine of claim 1, wherein each of the primary stator poles has a first winding and each auxiliary stator pole has second winding, and wherein the first and second windings of axially aligned primary and auxiliary stator poles are electrically connected.

9. The machine of claim 1, wherein each of the primary stator poles has a first winding and each auxiliary stator pole has second winding, and wherein the first and second windings of axially aligned primary and auxiliary stator poles exhibit opposite magnetic orientations.

10. The machine of claim 1, wherein multiple machines are stacked on a common axis of rotation.

11. The machine of claim 1, further comprising controlling circuitry coupled to drive windings on the stator poles.

12. A reluctance machine, comprising:
a rotor having a plurality of rotor poles and configured to rotate about an axis of rotation;
a stator having a plurality of stator poles, each stator pole comprising:
a primary stator pole; and
an auxiliary stator pole,
wherein each stator pole is formed of a plurality of laminations, said laminations extending in a direction parallel to the axis of rotation; and
wherein each lamination includes a first leg forming part of the primary stator pole, a second leg forming part of the auxiliary stator pole and a bridge member extending perpendicular to and joining the first and second legs.

13. The machine of claim 12, wherein each stator pole of the plurality of stator poles is magnetically isolated from each other stator pole of the plurality of stator poles.

14. The machine of claim 12, wherein the rotor includes a plurality of rotor poles, each rotor pole having a length extending in the direction of the axis of rotation sufficient to at least partially cover both the primary stator pole and auxiliary stator pole of one stator pole.

15. The machine of claim 12, wherein each primary stator pole has a first winding and each auxiliary stator pole has a second winding, and wherein the first and second windings of axially aligned primary and auxiliary stator poles are electrically connected.

16. The machine of claim 15, further comprising a drive circuit electrically connected to the first and second windings.

17. The machine of claim 15, wherein the first and second windings cause the primary and auxiliary stator poles to exhibit opposite magnetic orientations.
